(19) United States
(12) Patent Application Publication
(10) Pub. No.: US 2013/0039767 A1
(43) Pub. Date: Feb. 14, 2013

(54) BLADE ASSEMBLY FOR A MOBILE WIND TURBINE

(71) Applicants: Robert R. Schrickel, Oshkosh, WI (US); Brent R. Servin, Hortonville, WI (US); Stephen C. Nimmer, Oshkosh, WI (US)

(72) Inventors: Robert R. Schrickel, Oshkosh, WI (US); Brent R. Servin, Hortonville, WI (US); Stephen C. Nimmer, Oshkosh, WI (US)

(73) Assignee: Oshkosh Corporation

(21) Appl. No.: 13/569,609

(22) Filed: Aug. 8, 2012

Related U.S. Application Data
(60) Provisional application No. 61/521,229, filed on Aug. 8, 2011.

(51) Int. Cl. F03D 1/06

(52) U.S. Cl. 416/153

(57) ABSTRACT

A folding blade assembly for a mobile wind turbine system is disclosed that includes a hub configured to be coupled to a generator and a blade coupled to the hub with a movable joint. The movable joint includes a first member coupled to the hub and including an aperture, a second member coupled to the blade and including an aperture, and a pin extending through the apertures of the first and second members such that the second member is movable relative to the first member about the pin. The movable joint further includes a lock coupled to the first member and the second member and having an engaged position and a disengaged position, where the second member is movable relative to the first member when the lock is in the disengaged position.

### CROSS-REFERENCE TO RELATED APPLICATIONS

This patent application claims the benefit under 35 U.S.C. §119(e) of U.S. Prov. Pat. App. No. 61/521,229, entitled “Blade Assembly of a Wind Turbine,” filed on Aug. 8, 2011, which is hereby incorporated by reference in its entirety.

### BACKGROUND

The present invention generally relates to turbines for capturing energy from wind. More specifically, the invention relates to a blade assembly of a wind turbine system, such as a portable turbine.

A portable turbine may be used to provide a power source for equipment in many locations, including remote locations such as deserts, tundra, uninhabited islands, and jungles. In these locations, traditional power sources (e.g., batteries, tanks of fuel for use with engine-driven generators, etc.) may be spent without opportunity for refueling. By contrast, a portable wind turbine may be configured to provide a continuous source of renewable energy for extended deployments. Energy captured from wind may be converted into electricity by a generator integrated with the wind turbine and may be used to power equipment or may be stored in batteries, capacitors, or other energy storage devices for later use.

During travel to and from operational locations, the portable wind turbine may be stored in a compact configuration and deployed upon arrival. Such deployment of traditional mobile units may require tools, time, and manual effort to configure a wind turbine of a mobile generator system from a compact, storage configuration to an extended operational configuration. Additional tools, time, and effort may be needed for returning the wind turbine to storage. These deployment and storage processes may take an extended period of time and may be complicated by weather conditions that make operating tools particularly challenging. However, in some instances, the wind turbine may need to be rapidly stored, such as upon the approach of adverse weather or upon a tactical need to relocate. Similarly, the wind turbine may need to be rapidly deployed to provide, for example, electricity to power equipment or a mobile hospital. Accordingly, a need exists for a simple, robust blade assembly for a wind turbine that may be folded or otherwise assembled and disassembled in a manner that facilitates rapid deployment and storage of the wind turbine.

### SUMMARY

One embodiment of the invention relates to a folding blade assembly for a mobile wind turbine system. The assembly includes a hub configured to be coupled to a generator and a blade coupled to the hub with a movable joint. The movable joint includes a first member coupled to the hub and including an aperture, a second member coupled to the blade and including an aperture, and a pin extending through the apertures of the first and second members such that the second member is movable relative to the first member about the pin. The movable joint further includes a lock coupled to the first member and the second member and having an engaged position and a disengaged position, where the second member is movable relative to the first member when the lock is in the disengaged position.

Another embodiment of the invention relates to a blade assembly for a mobile wind turbine system. The assembly includes a hub configured to be coupled to a generator, an first elongated member coupled to the hub, a blade removably coupled to the first member with a fastener. The fastener includes a body element having a first aperture and a second aperture, where the first aperture is configured to receive an end of the first elongated member and the second aperture is configured to receive an end of the blade and a retainer configured to be received by a third aperture within the body element, where the first elongated member further comprises at least one of a detent, aperture, and lateral groove that interfaces with the retainer to limit the movement of the blade with respect to the first elongated member.

Yet another embodiment of the invention relates to a folding blade assembly for a mobile wind turbine system. The assembly includes a hub configured to be coupled to a generator, a first member having an aperture and coupled to the hub, and a second member having an aperture and coupled to the first member with a movable joint. The movable joint includes an interface formed along a contact surface between the first member and the second member and a pin extending through the apertures of the first and second members. The second member is movable relative to the first member about the pin. The movable joint further includes a lock coupled to the first member and the second member and having an engaged position and a disengaged position, where the second member is movable relative to the first member when the lock is in the disengaged position. The assembly further includes a blade removably coupled to the second member with a fastener. The fastener includes a body element having a first aperture and a second aperture, where the first aperture is configured to receive an end of the first elongated member and the second aperture is configured to receive an end of the blade. The fastener further includes a retainer configured to be received by a third aperture within the body element, where the first elongated member further comprises at least one of a detent, aperture, and lateral groove that interfaces with the retainer to limit the movement of the blade with respect to the first member.

Alternative exemplary embodiments relate to other features and combinations of features as may be generally recited in the claims.

### BRIEF DESCRIPTION OF THE FIGURES

The disclosure will become more fully understood from the following detailed description, taken in conjunction with the accompanying figures, in which:

FIG. 1 is a perspective view of a mobile wind turbine system according to an exemplary embodiment.

FIG. 2 is a perspective view of a blade assembly with one blade folded according to an exemplary embodiment.

FIG. 3 is a closer view of the hub and joints of the blade assembly of FIG. 2 taken along line 3-3 of FIG. 2.

FIG. 4 is a side view of a joint for a blade of a blade assembly in a first configuration according to an exemplary embodiment.

FIG. 5 is a side view of the joint of FIG. 4 in a second configuration.

FIG. 6 is a side view of the joint of FIG. 4 in a third configuration.

FIG. 7 is the opposite side view of the joint of FIG. 6.

FIG. 8 is a perspective view of a connector of a joint for a blade of a blade assembly according to an exemplary embodiment.

FIG. 9 is a side view of a pin of a joint for a blade of a blade assembly according to an exemplary embodiment.

FIG. 10 is a top view of components of a joint for a blade of a blade assembly according to an exemplary embodiment.

FIG. 11 is a sectional view of a joint for a blade of the blade assembly of FIG. 2 as taken along line 11-11 in FIG. 3.

FIG. 12 is a perspective view of a mobile wind turbine system according to another exemplary embodiment.

FIG. 13 is a perspective view of a joint of a blade assembly of the mobile wind turbine system of FIG. 12.

FIG. 14 is a side view of a blade assembly according to another exemplary embodiment.

FIG. 15 is a side view of the blade assembly of FIG. 14 taken along line 15-15 in FIG. 14.

FIG. 16 is a perspective view of a blade adapter of the blade assembly of FIG. 14.

FIG. 17 is a sectional view of the blade adapter of FIG. 16, taken along line 17-17 in FIG. 16.

FIG. 18 is an exploded view of the blade adapter of FIG. 16.

FIG. 19 is a side view of a blade assembly according to yet another exemplary embodiment.

FIG. 20 is a side view of the blade assembly of FIG. 19 taken along line 20-20 in FIG. 19.

FIG. 21 is a perspective view of a blade adapter of the blade assembly of FIG. 19.

FIG. 22 is a sectional view of the blade adapter of FIG. 21, taken along line 22-22 in FIG. 21.

FIG. 23 is an exploded view of the blade adapter of FIG. 21.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

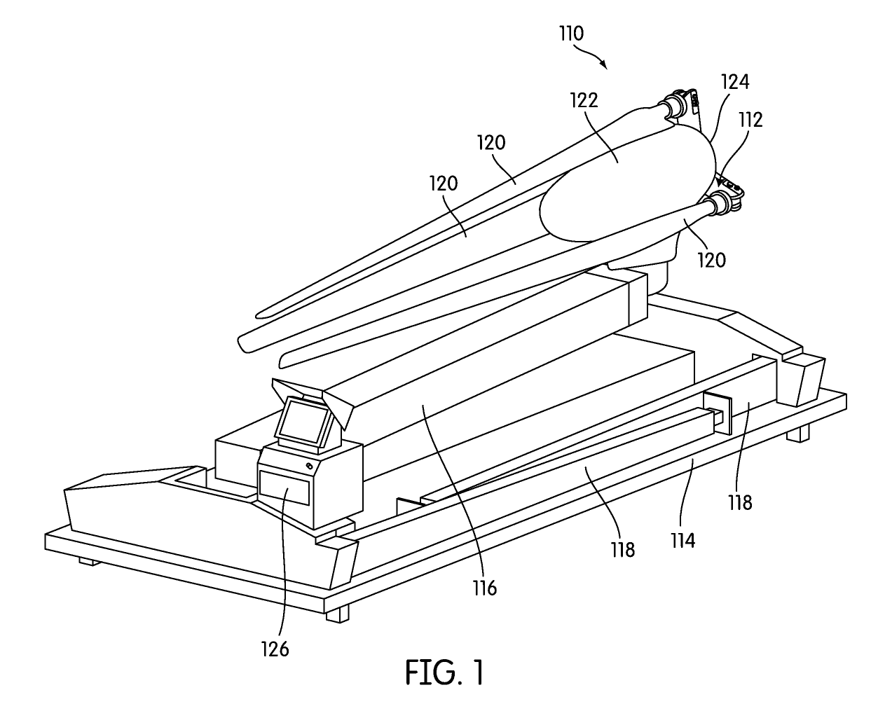

Referring to the exemplary embodiment shown in FIG. 1, a mobile system, shown as portable generator 110 may include a driver, shown as blade assembly 112 coupled to a base, shown as platform 114. Platform 114 provides an underlying support and may stabilize portable generator 110. As shown in FIG. 1, blade assembly 112 may include a plurality of airfoils, shown as blades 120 and a support, shown as hub 124. As an airflow passes over blades 120, blade assembly 112 may rotate about a centerline of blade assembly 112. Such rotation of blade assembly 112 may be used by portable generator 110 to turn a generator (not shown) and produce electricity or operate equipment. According to an alternative embodiment, portable generator 110 may be placed within another fluid (e.g., water, etc.). Such a portable generator may include blades 120 designed as hydrofoils that interact with the other fluid to produce electricity with a generator (not shown) or operate equipment.

According to the exemplary embodiment shown in FIG. 1, platform 114 may provide a portable base that further contributes to the mobility of portable generator 110. By way of example, platform 114 may be configured to be transported on a ground vehicle (e.g., on a truck bed, on a trailer, etc.), on an aerial vehicle (e.g., in a cargo bay of a transport or cargo aircraft, airlifted by helicopter, etc.), or otherwise transported. According to an alternative embodiment, blade assembly 112 may be mounted to a fixed tower or structure other than boom 116. Such transportation methods may impact the physical shape of platform 114. According to the exemplary embodiment shown in FIG. 1, platform 114 is rectangular. According to various alternative embodiments, platform 114 may have another shape or may include additional structural elements. As shown in FIG. 1, portable generator 110 may further include a plurality of stabilizers, shown as support legs 118 coupled to platform 114. According to an exemplary embodiment, support legs 118 may be extended outward from platform 114 to further steady portable generator 110.

As shown in FIG. 1, blade assembly 112 may be coupled to platform 114 through an intermediate support, shown as boom 116. Boom 116 may be an elongated structure having a first end mounted to platform 114 and a second end coupled to blade assembly 112. According to an exemplary embodiment, boom 116 may interface with support members (e.g., hydraulic cylinders, etc.) that extend to lift blade assembly 112 upward. Such lifting may facilitate the power generation of portable generator 110 by moving blade assembly 112 into an airflow having more preferred conditions (i.e. intensity, direction, etc.). According to an exemplary embodiment, blade assembly 112 may be rotated to position blades 120 at a specified angle (e.g., 0°, 5°, etc.) with respect to the air flow direction.

Referring still to the exemplary embodiment shown in FIG. 1, portable generator 110 may be configured in various positions. As shown in FIG. 1, portable generator 110 may be configured in a transport position. In the transport position, the boom 116 may be lowered and retracted, and blade assembly 112 may be stored in a compact, storage configuration. According to the exemplary embodiment shown in FIG. 1, blades 120 of the blade assembly 112 may be folded backward over a housing, shown as nacelle 122 and may extend over platform 114. Such a stored configuration provides a compact arrangement of blades 120 while transporting portable generator 110 with blades 120 attached, thereby reducing setup time upon arrival to a location. According to an alternative embodiment, blades 120 may be removably coupled. Transporting portable generator 110 with blades 120 detached may prevent damage to blades 120 or portable generator 110.

According to an exemplary embodiment, the portable generator may be positioned into an elevated position with the blade assembly lifted such that the boom is approximately vertical with respect to a ground surface. The blade assembly may be raised still further into an extended position by extending (e.g., telescoping, etc.) various sections of the boom. Such extension may be facilitated by a driver (e.g., electric driver, hydraulic cylinder, etc.).

Referring still to the exemplary embodiment shown in FIG. 1, portable generator 110 may further include a control system 126. As shown in FIG. 1, control system 126 may be coupled to at least one of boom 116 and platform 114. According to an alternative embodiment, control system 126 may interact with the various components of portable generator 110 remotely. Control system 126 may serve various purposes such as operate boom 116, control the power generated by blade assembly 112, and interact with alternate power sources that may be coupled to the platform 114, among other purposes. By way of example, such alternate power sources may include solar cells and engine-driven generators, among others, that may operate in place of or in conjunction with blade assembly 112.

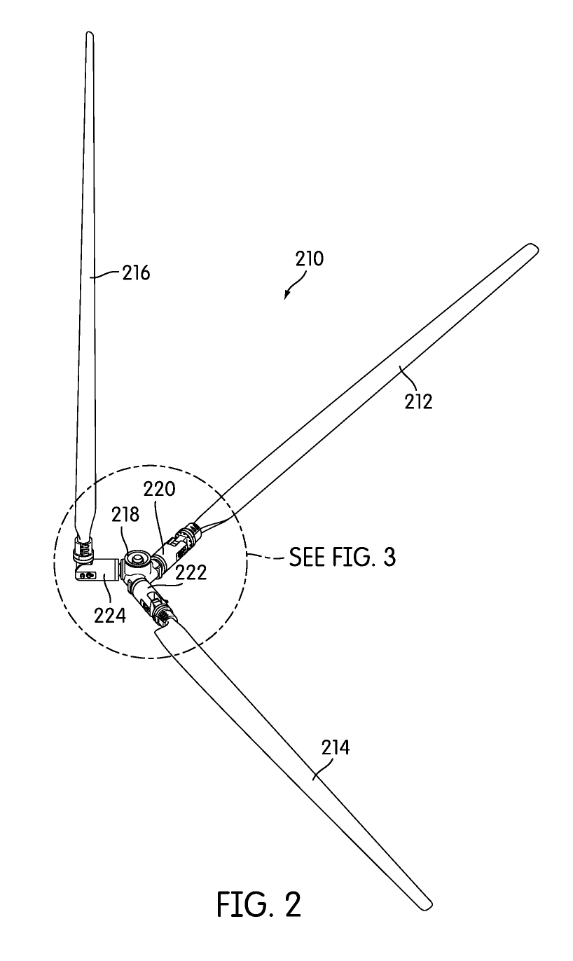

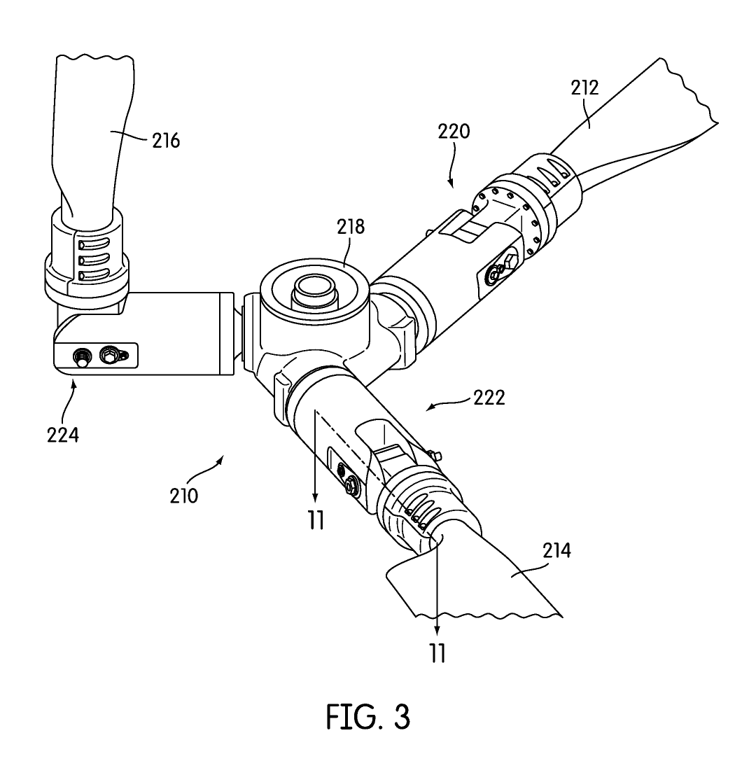

Referring next to the exemplary embodiment shown in FIGS. 2-3, portable generator 110 may include a driver, shown as blade assembly 210. As shown in FIG. 2, blade assembly 210 may include a plurality of airfoils, shown as blades 212, 214, and 216. When the portable generator is configured in either the elevated position or the extended position, such as those discussed above, the blades may be rotated forward from the folded position of blade 216 into an extended position of blades 212 and 214. While blade assembly 210 shown in FIGS. 2-3 includes three blades 212, 214, 216, blade assembly 210 may include more or fewer blades, according to various alternative embodiments.

Referring still to the exemplary embodiment shown in FIGS. 2-3, blades 212, 214, and 216 may extend from a support, shown as hub 218. As shown in FIGS. 2-3, blades 212, 214, and 216 may be coupled to hub 218 by movable couplers, shown as joints 220, 222, and 224. According to an exemplary embodiment, blades 212, 214, and 216 and joints 220, 222, and 224 may be modular (i.e., interchangeable) such that they may be replaced by similar blades or joints. Furthermore, joints 220, 222, and 224 may be configured to receive a wide variety of differently designed blades. Such a design allows for blades having various designs or mounting configurations to be coupled with hubs having different characteristics (e.g., having a different mounting hole pattern, having a different mounting structure, etc.). Although designed for loading and operational requirements of mobile systems, the joints for blades of wind turbines disclosed herein may apply to other technologies or applications and are not limited to mobile wind turbines.

According to the exemplary embodiment shown in FIGS. 2-3, joints 220, 222, and 224 may be coupled to hub 218. Such coupling may occur through the use of various known fasteners (e.g., bolts, screws, a collar, etc.). As shown in FIGS. 2-3, joints 220, 222, and 224 may extend tangentially from the periphery of hub 218 such that blades 212, 214, and 216 rotate in a specified direction about the centerline of hub 218. According to various alternative embodiments, joints 220, 222, and 224 may extend in other directions relative to the periphery of hub 218.

As shown in FIGS. 2-3, joints 220, 222, and 224 allow blades 212, 214, and 216 to be folded (e.g., rotated, maneuvered, etc.) relative to hub 218. Such folding may provide the benefit of configuring blade assembly 210 into a storage position and into an operational position quickly and without removing blades 212, 214, and 216, among other benefits. As shown in FIGS. 2-3, blades 212 and 214 are configured in an operational position and blade 216 is folded for storage. It should be understood that the configuration shown in FIGS. 2-3 shows only a representative position of blades 212, 214, and 216 and that each of blades 212, 214, and 216 may be extended for operation or folded for storage. According to an exemplary embodiment, blades 212, 214, and 216 may be folded backward in the configuration of blade 216 for storage. According to an alternative embodiment, blades 212, 214, and 216 may all be folded forward, opposite the configuration of blade 216, for storage.

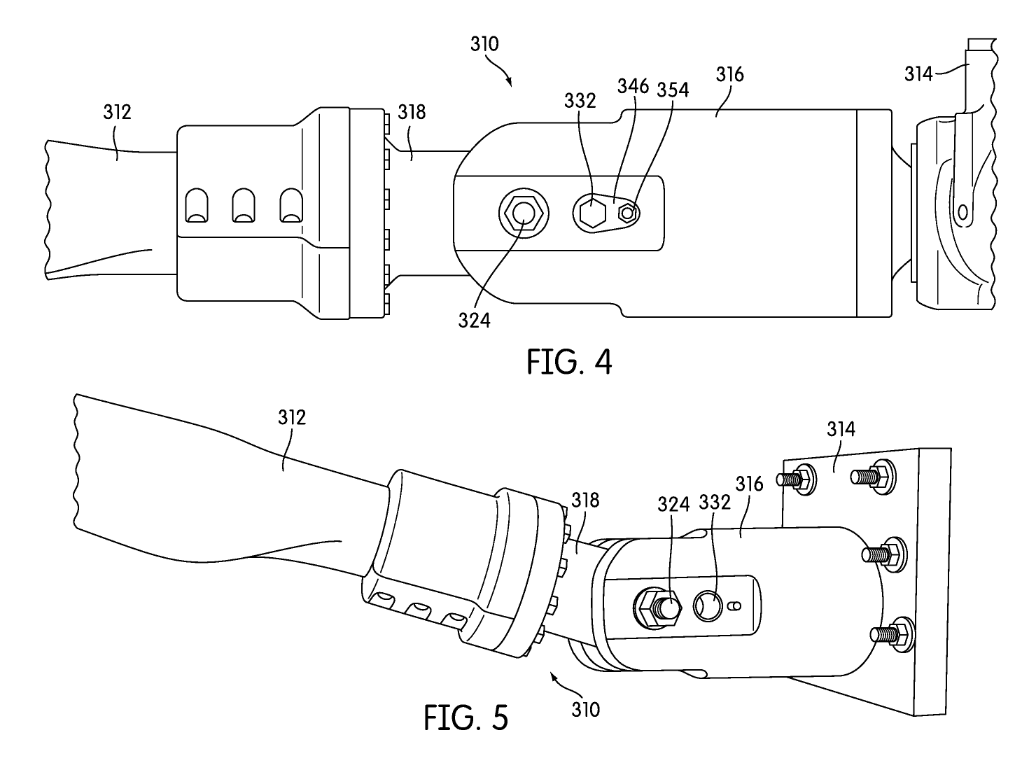

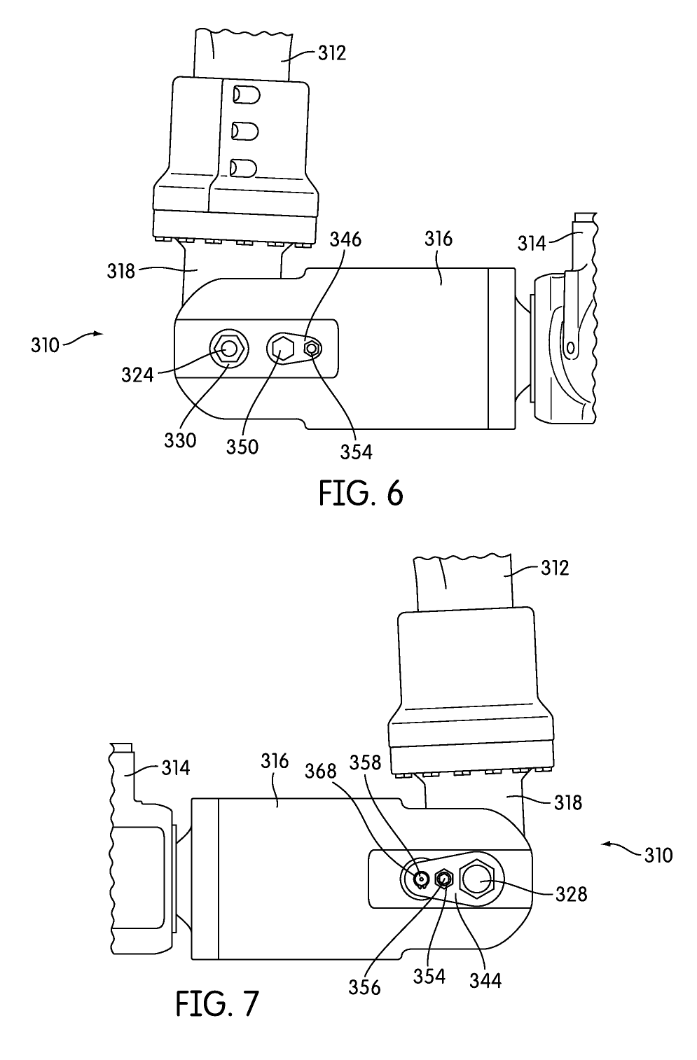

Referring next to the exemplary embodiment shown in FIGS. 4-7, a movable coupler, shown as joint 310 may include a first portion (e.g., part, segment, member, etc.) shown as first connector 316 and a second portion (e.g., part, segment, member, etc.) shown as second connector 318. As shown in FIGS. 4-7, joint 310 may couple an airfoil, shown as blade 312 to a support, shown as hub 314. According to an exemplary embodiment, first connector 316 may be fastened to hub 314, and second connector 318 may be fastened to blade 312. Such a joint 310 may allow for relative movement between first connector 316 and second connector 318 such that joint 310 may be positioned in various configurations. According to the exemplary embodiment shown in FIG. 4, joint 310 may be positioned in a first configuration (e.g., an operational configuration). According to the alternative embodiment shown in FIG. 5, joint 310 may be positioned in a second configuration where second connector 318 is angled relative to the first connector 316. According to still another alternative embodiment shown in FIGS. 6-7, joint 310 may be positioned in a third configuration (e.g., storage configuration) where second connector 318 is angled between 30° and 150°, preferably between 70° and 110° relative to first connector 316.

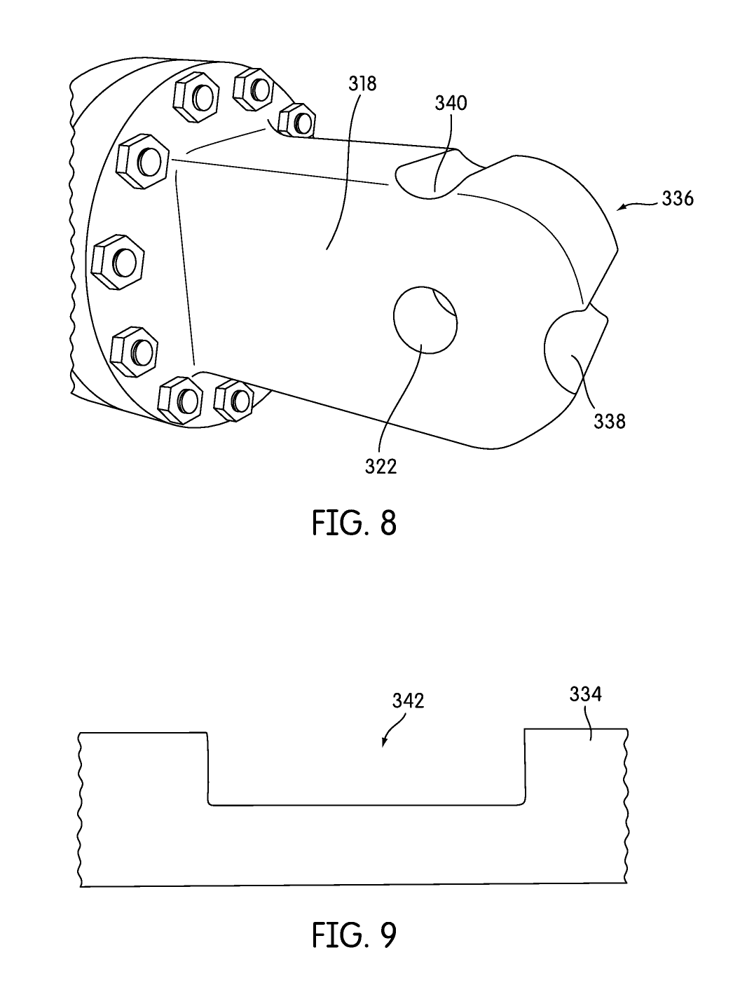

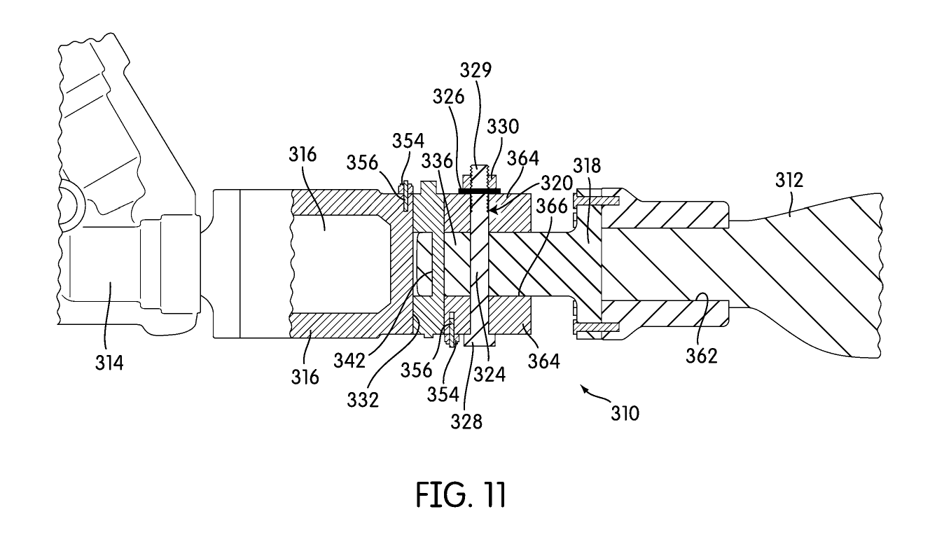

According to the exemplary embodiment shown in FIGS. 4-11, first connector 316 and second connector 318 may include apertures to facilitate relative movement between first connector 316 and second connector 318. As shown in FIG. 8, second connector 318 may include a space (e.g., hole, void, etc.), shown as aperture 322. According to the exemplary embodiment shown in FIG. 11, first connector 316 may also include a space (e.g., hole, void, etc.), shown as aperture 320.

As shown in FIG. 11, joint 310 may further include a pivot member, shown as spindle 324. Spindle 324 may be comprised of various known materials (e.g., steel, forged aluminum, etc.). As shown in FIG. 11, the apertures 320 and 322 of first connector 316 and second connector 318 may be aligned and configured to receive spindle 324 to allow rotation of second connector 318 and blade 312 about spindle 324 relative to first connector 316 and hub 314.

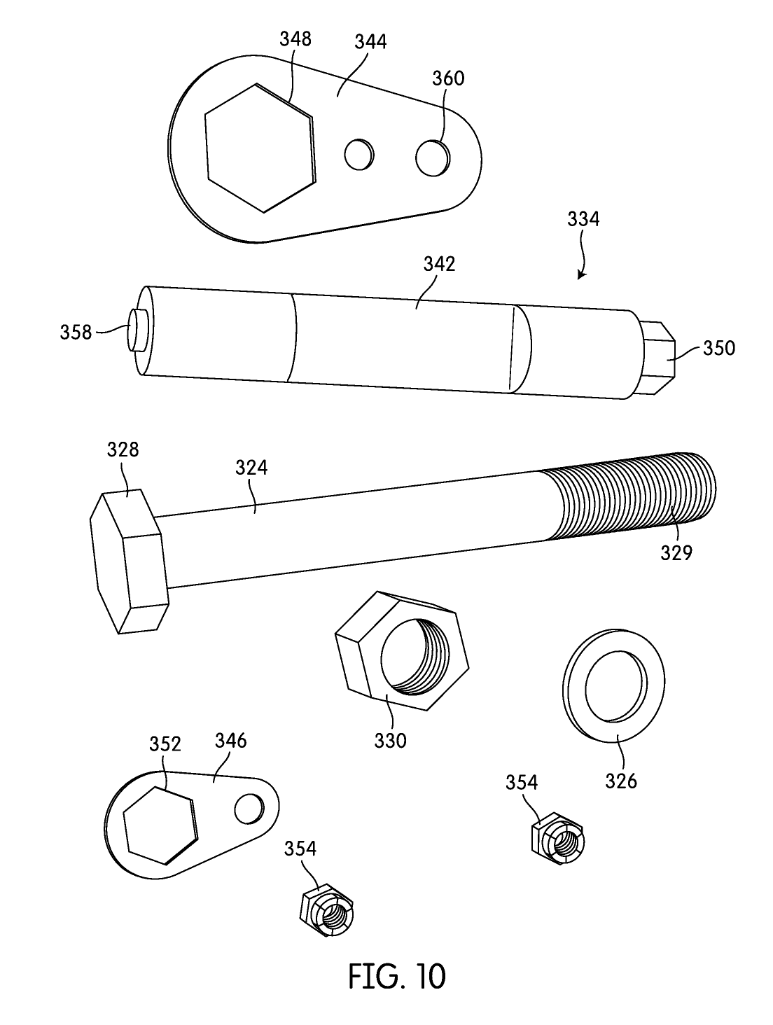

Referring still to the exemplary embodiment shown in FIGS. 4-11, spindle 324 may include a first end, shown as head portion 328 and a second end, shown as coupling portion 329. As shown in FIG. 10, head portion 328 may have a specified shape (e.g., square, hexagonal, etc.). Head portion 328 having a specified shape may allow for the control of the rotation of spindle 324. Such control may include preventing spindle 324 from rotating or providing a rotational torque to spindle 324. According to the exemplary embodiment shown in FIG. 11, joint 310 may further include a ring, shown as washer 326 and a fastener, shown as nut 330. As shown in FIG. 11, washer 326 and nut 330 may be aligned coaxially with spindle 324, and nut 330 may interface with coupling portion 329.

As shown in FIG. 11, nut 330 may be tightened or loosened to vary the contact forces between first connector 316 and second connector 318 thereby varying the input force required to move joint 310. According to an exemplary embodiment, tightening nut 330 on coupling portion 329 of spindle 324 applies a compressive force that limits relative movement between first connector 316 and second connector 318 and may hold first connector 316 and second connector 318 in a particular configuration (e.g., operational or storage configurations). According to various alternative embodiments, spindle 324 may be retained by another form of fastener configured to receive coupling portion 329, another type of female coupling configured to secure spindle 324 within first connector 316, or a threaded connection integrated with at least one of the first connector 316 and second connector 318, among other known methods of retaining spindle 324.

Referring still to FIGS. 4-11, joint 310 may further include a catch, shown as pin 334. According to the exemplary embodiment shown in FIG. 10, pin 334 is cylindrical. Pin 334 may be comprised of a variety of known materials (e.g. steel, iron, a composite, a polymer, etc.). According to various alternative embodiments, pin 334 may include a variety of other known shapes (e.g., square bar, rectangular bar, hexagonal bar, a lever, etc.). As shown in FIG. 11, pin 334 may prevent the rotation of first connector 316 relative to second connector 318 through physical interference between the elements of joint 310. According to an exemplary embodiment, such physical interference may include pin 334 engaging with a protrusion of second connector 318, shown as elongated end 336. According to an exemplary embodiment, pin 334 may also engage a portion of first connector 316 to prevent the rotation of first connector 316 relative to second connector 318. According to still other alternative embodiments, pin 334 may engage other components of joint 310 to prevent the movement of first connector 316 to second connector 318.

As shown in FIGS. 5 and 11, first connector 316 may further include a space (e.g., hole, void, etc.), shown as second aperture 332. According to an exemplary embodiment, second aperture 332 may be parallel to aperture 320. According to various alternative embodiments, second aperture 332 may be arranged perpendicular to aperture 320 or may be arranged at another angle with respect to aperture 320. Second aperture 332 may be positioned in any suitable position along first connector 316 and second connector 318. By way of example, second aperture 332 may be located closer to hub 314 than aperture 320, further from hub 314 than aperture 320, within the same plane as aperture 320, or located in another position. As shown in FIG. 11, second aperture 332 may be configured to receive pin 334 while allowing pin 334 rotate and slide relative to first connector 316.

As shown in FIG. 8, second connector 318 may further include a plurality of apertures (e.g., holes, grooves, slots, etc.), shown as spaces 338 and 340 disposed proximate to elongated end 336. Spaces 338 and 340 may correspond to a different orientation of second connector 318 relative to first connector 316. The various orientations may include an operational position as shown in FIG. 4 and a storage position as shown in FIG. 6. As shown in FIG. 8, spaces 338 and 340 may comprise a semicircular cross section positioned across a length of second connector 318. Such spaces 338 and 340 may be parallel to aperture 322 or at an angle relative to aperture 322. According to an exemplary embodiment, spaces 338 and 340 include a circular portion configured to receive a portion of pin 334. By way of example, spaces 338 and 340 may have a radius or diameter equal to a radius or diameter of pin 334. According to an exemplary embodiment, spaces 338 and 340 comprise two or more apertures proximate to elongated end 336 of second connector 318, and each of the apertures may correspond to a different orientation of the second connector 318 relative to the first connector 316. According to various alternative embodiments, spaces 338 and 340 may have different shapes (e.g., square, rectangular, hexagonal, etc.) or different orientations. The shape and size of spaces 338 and 340 may be specified and vary based on the loading or stresses imparted by the various components of the blade assembly. While the foregoing discussion included various spaces disposed proximate to an end of second connector 318, a person of ordinary skill in the relevant art would understand that such spaces may alternatively be positioned proximate an end of first connector 316 or another component of join 310.

According to the exemplary embodiment shown in FIGS. 9 and 11, pin 334 may be operable between a first position and a second position to optionally limit relative movement between first connector 316 and hub 314 and second connector 318 and blade 312 by engaging one of spaces 338 and 340. Pin 334 may be actuated between the first position and the second position by rotating pin 334 within second aperture 332 or by removing pin 334 from second aperture 332. According to the exemplary embodiment shown in FIG. 9, pin 334 may include a semicircular section 342 having a rounded side and a flat side. As shown in FIG. 11, semicircular section 342 may interface with spaces 338 and 340 shown in FIG. 8. Pin 334 may be operable between a first position and a second position located approximately 180° from the first position about a centerline of pin 334.

In the first position, the rounded portion of the semicircular section 342 faces second connector 318 and at least partially fills one of spaces 338 and 340 thereby fixing the orientation of second connector 318 relative to first connector 316. When pin 334 is rotated more than 90° within second aperture 332 to the second position, the flat side of semicircular section 342 faces towards second connector 318. In the second position, pin 334 does not engage the elongated end 336 of second connector 318 thereby allowing second connector 318 to rotate relative to first connector 316. Even with pin 334 in the second position, friction between first connector 316 and second connector 318 or compression caused by spindle 324 may still interlock first connector 316 and second connector 318. As shown in FIG. 11, pin 334 may be disposed within second aperture 332 in both the first position and second position. Pin 334 having a first position and a second position within second aperture 332 may reduce the reconfiguration time for the mobile wind turbine system and prevent a user from losing pin 334.

According to an alternative embodiment, pin 334 may have a uniform cross section. Such a pin 334 may be actuated between a first position within second aperture 332 and a second position outside second aperture 332 (i.e. where pin 334 is removed from second aperture 332) by sliding or rotating pin 334. In the first position, pin 334 may engage one of spaces 338 and 340 to prevent movement between first connector 316 and second connector 318. With pin 334 in the second position, first connector 316 and second connector 318 may rotate relative to one another.

According to an exemplary embodiment, movement of the pin between the first and second positions may be facilitated by one or more assistive elements. Such assistive elements may physically interact with the pin (e.g., torsional springs, resilient members, actuators, etc.) or otherwise interact with the pin (e.g., electrically, magnetically, etc.). According to an exemplary embodiment, assistive elements may be used to lock a portion of the joint into place by automatically engaging or disengaging the pin when the blade is rotated into an operational position or when the blade is folded into a storage position. According to an alternative embodiment, movement between the first and second positions may not be facilitated by assistive elements. According to still other alternative embodiments, magnets may be used to guide or otherwise facilitate fastening of any of the joints, fasteners, pins, or adapters disclosed herein.

According to an alternative embodiment, the first and second connectors may be coupled together using a joint having a first and second half, a pivot pin, and a retainer system. Such a joint may include a first and second halves, both having flat ends and a pivot pin positioned within a housing extending laterally across the two halves of the joint (i.e., a hinge connection, etc.). The retainer system may include a support member removeably coupled to the flat ends of the first and second joint halves. By way of example, the support member may be removeably coupled to the flat ends of the first and second joint halves using a bolted connection, among other known methods.

According to still another alternative embodiment, the first and second connectors may be coupled together using a joint having a first and second half, a pivot pin, and a retainer system where the first half includes an extended portion that projects into a receiving portion of the second half. Such a joint may include a pivot pin positioned through both halves of the joint. The retainer system for such a joint may include one or more stops configured to fix the first half relative to the second half. By way of example, the retaining system may include two stops configured to hold the joint in an operational position and two stops configured to hold the joint in a storage position by contacting both the extended portion of the first half and the second half of the joint. Such stops may include pins configured to extend parallel or perpendicular to the pivot pin and through a portion of the first and second half of the joint. According to an alternative embodiment, the retainer system for a joint including a first half having an extended portion may include a stop that engages a toothed (i.e. notched, serrated, etc.) end of the extended portion. The stops may be secured relative to the first and second joint halves with locking plates (i.e. releasably coupled to the first and second joint halves but fixed while the locking plates are in place) or may be movable relative to the first and second joint halves with an actuator. Such an actuator may include a various known devices (e.g., a spring, pneumatic system, hydraulic system, electrical actuator, etc.).

Referring next to FIGS. 6-7, joint 310 may further include a first keeper, shown as first limiter 344 and a second keeper, shown as second limiter 346. According to an exemplary embodiment, first limiter 344 and second limiter 346 may prevent spindle 324 and pin 334 from rotating within aperture 322 and second aperture 332. Preventing the rotation of spindle 324 and pin 334 may allow a user to tighten nut 330 with fewer tools or retain pin 334 in at least one of the first position and the second position. As shown in FIGS. 6-7, first limiter 344 and second limiter 346 may be coupled to opposite sides of first connector 316. According to an alternative embodiment, first limiter 344 and second limiter 346 may be coupled to another component of joint 310. According to still other alternative embodiments, joint 310 may include either first limiter 344, second limiter 346, or may not include first limiter 344 or second limiter 346.

According to the exemplary embodiment shown in FIGS. 6-7, first limiter 344 and second limiter 346 may be coupled to first connector 316 using a protrusion (e.g., bolt, screw, etc.) shown as stud 356 and a coupler (e.g., nut, snap ring, etc.) shown as fastener 354. Stud 356 may extend from first connector 316 and may be threaded into first connector 316. First limiter 344 and second limiter 346 may be secured by a threaded connection between stud 356 and fastener 354.

According to the exemplary embodiment shown in FIGS. 6-7, first limiter 344 and second limiter 346 may be released by loosening or removing fastener 354, which may allow first limiter 344 or second limiter 346 to be rotated or lifted away from first connector 316. Removeably coupling first limiter 344 and second limiter 346 to first connector 316 provides the advantage of selectively allowing rotation of spindle 324 and pin 334 when first limiter 344 and second limiter 346 are removed. By way of example, selective rotation of pin 334 may be advantageous in order to actuate pin 334 from the first position to the second position. According to various alternative embodiments, first limiter 344 and second limiter 346 may be coupled to first connector 316 using other known means (e.g., a snap fitting, a retainer utilizing a spring and interference connection, etc.).

According to the exemplary embodiment shown in FIGS. 6-7, first limiter 344 and second limiter 346 may include apertures configured to receive and end of at least one of spindle 324 and pin 334. As shown in FIGS. 6-7, spindle 324 may include head portion 328 having a polygonal periphery, and first limiter 344 may be configured to engage the polygonal periphery of head portion 328 within a mating aperture. According to the exemplary embodiment shown in FIGS. 6-7, first limiter 344 holds head portion 328 to prevent the rotation of spindle 324 while an operator adjusts (e.g., tightens, loosens, etc.) nut 330. According to an alternative embodiment, first limiter 344 may hold nut 330 while a user rotates head portion 328 of spindle 324.

As shown in FIGS. 6-7, first limiter 344 may further include an aperture configured to receive guide portion (i.e., stud, boss, etc.) shown as first end 358 of pin 334. Such an aperture may have a circular shape having a diameter approximately equal to a corresponding diameter of first end 358. First limiter 344 may further include a fastener, shown as snap ring 368 disposed proximate first end 358 of pin 334 that partially limits the movement of pin 334. By way of example, snap ring 368 may prevent pin 334 from sliding out of second aperture 332. As shown in FIGS. 6-7, first limiter 344 may allow pin 334 to rotate relative to first limiter 344 and thereby facilitate the actuation of pin 334 from the first position to the second position without allowing pin 334 to move laterally relative to first connector 316. First end 358 may allow for alignment of first limiter 344 along first connector 316 and may provide leverage for the first limiter 344 to further secure head portion 328.

According to the exemplary embodiment shown in FIGS. 6-7, second limiter 346 may include an aperture configured to receive an end of at least one of spindle 324 and pin 334. As shown in FIG. 6, pin 334 (not shown) may include an opposite end, shown as second end 350 having a polygonal periphery, and second limiter 346 may be configured to engage the polygonal periphery of end 350 within a mating aperture. According to the exemplary embodiment shown in FIG. 6, second limiter 346 holds second end 350 to prevent the rotation of pin 334. By way of example, preventing the rotation of pin 334 may reduce the risk that first connector 316 may move relative to second connector 318 when joint 310 is intended to be held in the operational or storage configuration.

Referring again to the exemplary embodiment shown in FIGS. 4 and 6-7, joint 310 may be further secured into a storage position by first limiter 344 and second limiter 346. As shown in FIGS. 6-7, first limiter 344 and second limiter 346 are fastened to opposite sides of the first connector 316 proximate to head portion 328, first end 358, and second end 350. First limiter 344 is shown in FIG. 7 fastened to first connector 316 and interlocking head portion 328 of spindle 324. Second limiter 346 is shown in FIG. 6 fastened to the first connector 316 and interlocking the end 350 of the pin 334. As shown in FIGS. 6-7, second connector 318 may be arranged and held in place by first limiter 344 and second limiter 346 at an angle of approximately 90° relative to first connector 316. According to an alternative embodiment, second connector 318 may be arranged and held in place by first limiter 344 and second limiter 346 at another angle (i.e. 10°, 20°, 30°, etc.) relative to first connector 316. Such an angle may facilitate the storage or transportation of the blades of the mobile wind turbine (e.g., blade 312, etc.). As shown in FIG. 4, second connector 318 may be held in place by first limiter 344 and second limiter 346 at an angle of between 0° and 5° relative to first connector 316. Such an angle may facilitate the operation of the mobile wind turbine. While the angles of 0°, 10°, 20°, 30°, and 90° are discussed above, various other angles may suffice for the storage or operation of the mobile wind turbine.

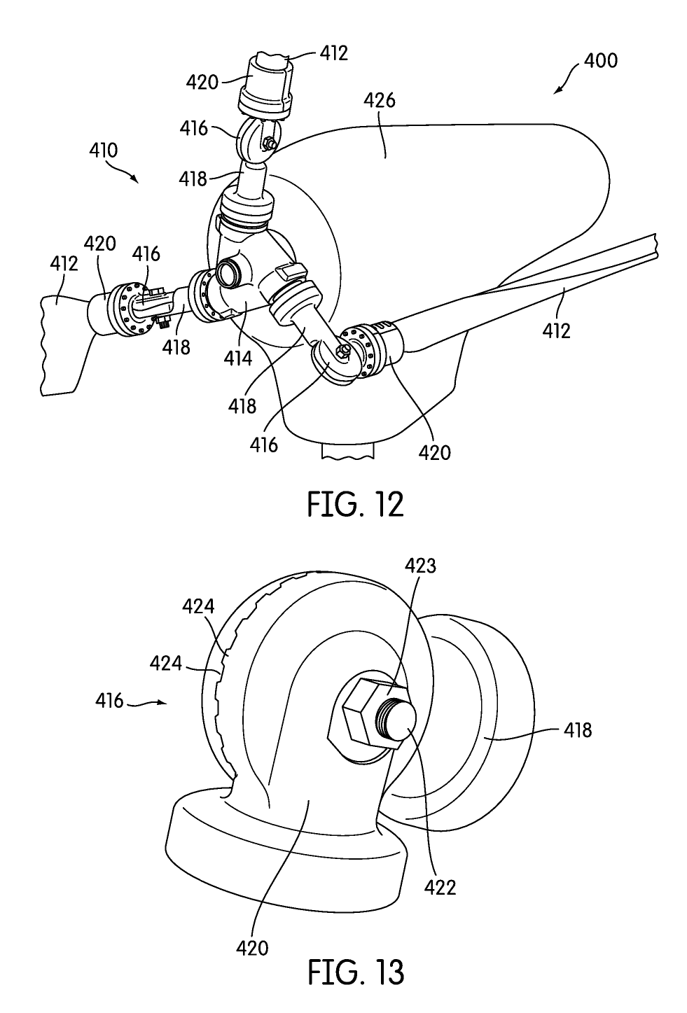

Referring next to the exemplary embodiment shown in FIGS. 12-13, a mobile wind turbine 400 may include a driver, shown as blade assembly 410 coupled to a housing, shown as nacelle 426. According to an exemplary embodiment, nacelle 426 may include a generator (not shown) configured to convert mechanical energy, in the form of rotation of the blade assembly 410, to electricity. As shown in FIG. 12, blade assembly 410 may include a plurality of airfoils, shown as blades 412 coupled to a central structural unit, shown as hub 414. Hub 414 may be coupled to the generator within nacelle 426 to facilitate the conversion of mechanical energy from blades 412 into electrical energy.

According to the exemplary embodiment shown in FIG. 12, blades 412 of blade assembly 410 may fold in order to further promote transportability of mobile wind turbine 400. Such folding may involve blades 412 rotating away from nacelle 426 (i.e. forward) or towards and over nacelle 426 (i.e. backward). Folding blades 412 may improve the transportability of mobile wind turbine 400 by more compactly storing blades 412. As shown in FIG. 12, two of the blades 412 of the blade assembly 410 are extended in an operational configuration (i.e. straight position), and one is folded in the storage configuration (e.g., folded position).

Referring still to the exemplary embodiment shown in FIG. 12, blades 412 are coupled to hub 414 with joints 416. As shown in FIG. 12, joints 416 may include a first member, shown as first connector 418 coupled to a second member, shown as second connector 420. First connector 418 and second connector 420 may each include an aperture configured to receive a rod, shown as pin 422 therethrough. Pin 422 may comprise a variety of known hardware configurations (e.g., a threaded bolt and nut, a snap ring and rod, a press fitting, etc.). As shown in FIGS. 12-13, pin 422 is a bolt having a threaded portion removeably coupled to a fastener, shown as nut 423. According to an exemplary embodiment, pin 422 may extend through the apertures within first connector 418 and second connector 420 to provide a pivot point for joint 416 and allow relative movement between first connector 418 and second connector 420. As shown in FIGS. 12-13, a user may tighten nut 423 to limit relative movement within joint 416 by compressing the engaging surfaces of first connector 418 and second connector 420 together.

According to the exemplary embodiment shown in FIG. 13, first connector 418 and second connector 420 may each include locking bodies, shown as engagement members 424. As shown in FIG. 13, engagement members 424 may include a plurality of interlocking teeth having a contact surface. Compressing first connector 418 into second connector 420 may force the contact surfaces of engagement members 424 together and limit the relative movement between first connector 418 and second connector 420. Providing engagement members 424 may prevent first connector 418 from moving relative to second connector 420 during the operation or storage of mobile wind turbine 400. Engagement members 424 may further provide for an indexable adjuster allowing for specified positioning blades 412 relative to hub 414.

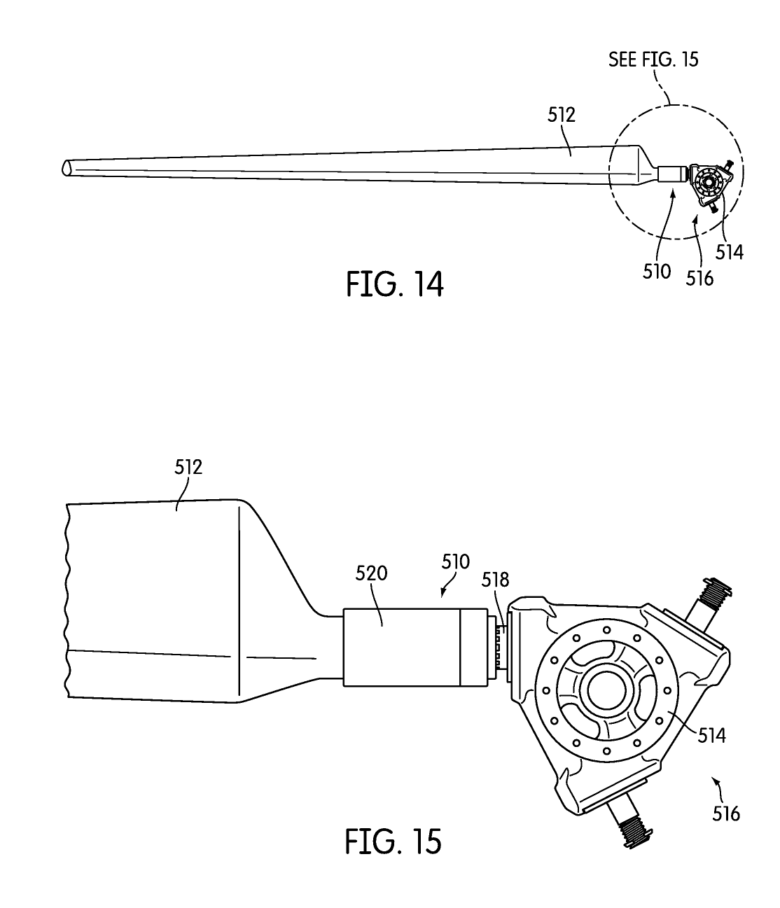

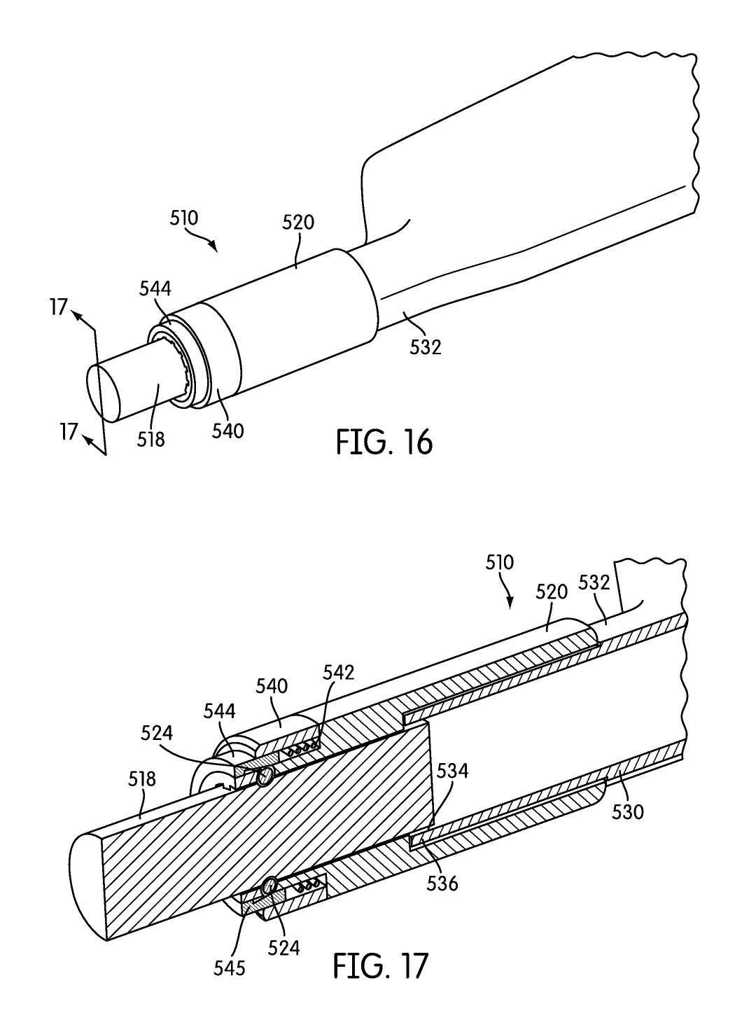

Referring next to FIGS. 14-18, a driver, as shown as blade assembly 516 is shown according to an exemplary embodiment. As shown in FIG. 14, blade assembly 516 may include a center structural support, shown as hub 514, a vane, shown as blade 512, and an adapter, shown as coupler 510. Coupler 510 may allow for the removal of blades 512 from hub 514 to further increase the mobility of a mobile wind turbine unit. Such mobility may be increased by removing blades 512 from hub 514 and arranging them in a storage position that is detached from hub 514. Such a storage position may be located within a mobile wind turbine unit or another suitable position (i.e. on a separate transport vehicle, etc.). Removing blade 512 from hub 514 may reduce structural loads that would otherwise be transferred to hub 514 or the other components of a mobile wind turbine unit (i.e. nacelle, boom, etc.) during transport and redeployment of a mobile turbine system. Coupler 510 may also distribute bending loads imparted onto blade 512 among hub shaft 518, shaft 532, and blade collar 520. Such distribution may reduce the loading experienced by any single element or two connecting elements of blade assembly 516.

According to the exemplary embodiment shown in FIGS. 15-18, coupler 510 comprises a ball bearing slip collar system. Such a coupler 510 may provide quick, accurate, and simple attachment and detachment of blades 512 from hub 514 without the use of tools (e.g., wrench, socket, screwdriver, etc.). As shown in FIGS. 15-17, hub 514 may include an interfacing member, shown as hub shaft 518 extending outward from the center of hub 514. Hub shaft 518 may be integrally formed with hub 514 or may comprise a separate component coupled with hub 514 according to a known technique (i.e. welded, threaded connection, press fit, thermally fit, etc.).

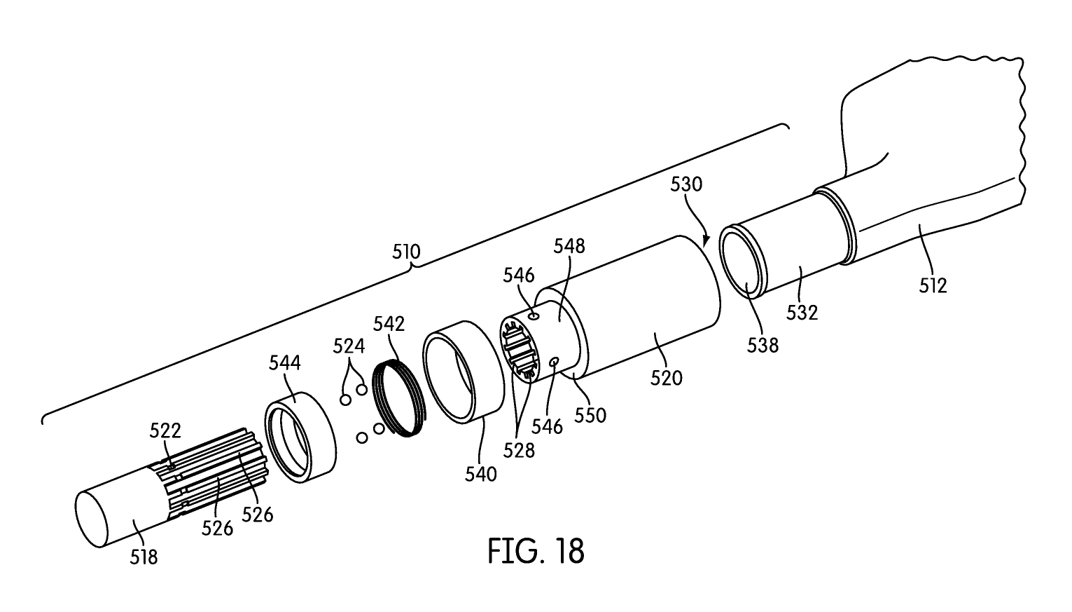

As shown in FIGS. 15-18, coupler 510 may include a sleeve, shown as blade collar 520. Blade collar 520 may be configured to receive an end of blade 512, shown as shaft 532. As shown in FIG. 18, blade collar 520 may include an aperture 530 extending from a second end opposite the first end and configured to receive shaft 532. Shaft 532 may further include a locking lip proximate to the end of shaft 532 configured to secure blade 512 within blade collar 520. According to an exemplary embodiment, blade collar 520 further includes an interface portion, shown as mating spline 528. Mating spline 528 and aperture 530 allow blade collar 520 to receive both the shaft 532 and hub shaft 518. As shown in FIG. 21, shaft 532 may further include an aperture 538 configured to receive a portion of hub shaft 518. According to an alternative embodiment, hub shaft 518 may include an aperture configured to receive an end of shaft 532. According to still another alternative embodiment, hub shaft 518 may be coupled to shaft 532 (e.g., with a lip, threaded, etc.) within blade collar 520.

As shown in FIG. 18, hub shaft 518 may further include a plurality of lengthwise grooves forming along a rotational coupling portion, shown as spline 526. Spline 526 may be configured to limit the rotation of blade collar 520 or various components of coupler 510 about a centerline of hub shaft 518. Such a spline 526 may engage mating spline 528 formed within an aperture extending from a first end of blade collar 520.

According to the exemplary embodiment shown in FIGS. 15-18, coupler 510 may further include a retainer, shown as sleeve 540, a resilient member, shown as compression spring 542, a locking element (e.g., snap rings, ball bearings, etc.), shown as fastening element 524, and a compressor, shown as lock ring 544. As shown in FIG. 18, blade collar 520 may include an extended portion, shown as protrusion 548 having a plurality of apertures 546 configured to receive fastening elements 524. Blade collar 520 may further include a compression surface, shown as ledge 550 extending between an outer surface of blade collar 520 and a surface of protrusion 548. As shown in FIG. 17, compression spring 542 may be positioned coaxially with blade collar 520 and received onto protrusion 548. Thereafter, sleeve 540 and lock ring 544 may be positioned over compression spring 542 and fastening elements 524. As shown in FIG. 17, lock ring 544 may include a tapered portion, shown as ramp 545.

According to an exemplary embodiment, sliding lock ring 544 along protrusion 548 towards ledge 550 positions ramp 545 over apertures 546 within protrusion 548. A user may then freely slide hub shaft 518 into blade collar 520 thereby lifting fastening elements 524 outward through apertures 546. According to an exemplary embodiment, hub shaft 518 includes a locking portion, shown as lateral groove 522. Lateral groove 522 may be configured to interface with fastening elements 524. When the user moves hub shaft 518 fully into position relative to blade collar 520, fastening elements 524 rest within lateral groove 522 on hub shaft 518. A user may then release lock ring 544, and compression spring 542 may again bias lock ring 544 over fastening elements 524. Such operation allows a user to complete the entire operation of connecting or disconnecting blade 512 using the coupler 510 by hand (i.e. without tools, manually, etc.).

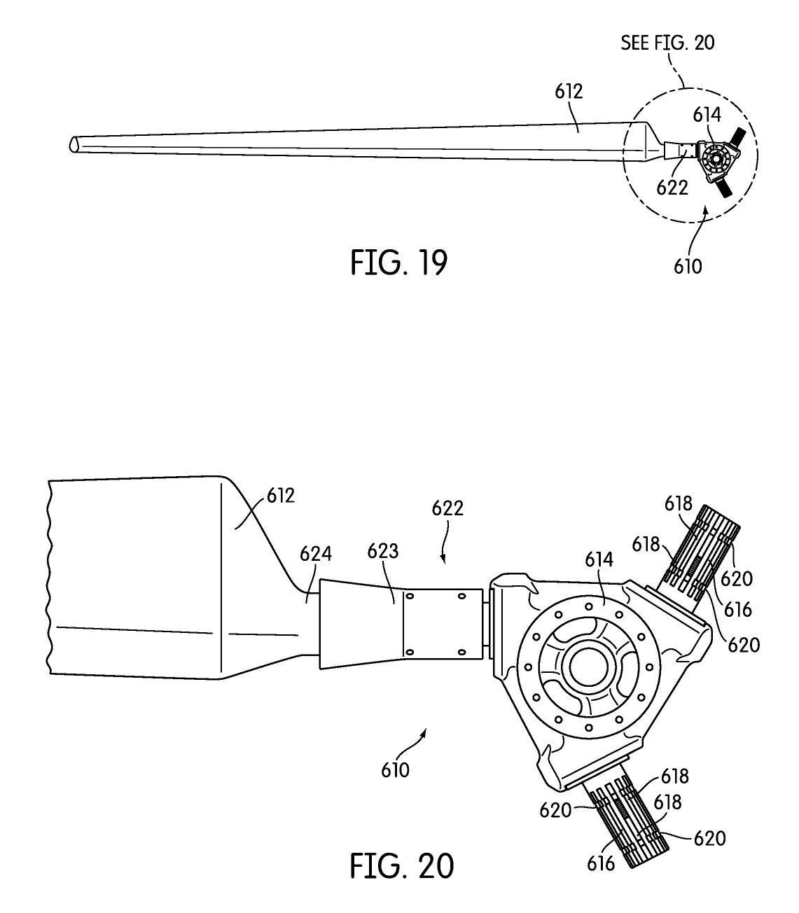

Referring next to the exemplary embodiment shown in FIGS. 19-23, a driver, shown as blade assembly 610 may include a vane, shown as blade 612, a structural member, shown as hub 614, and a coupler, shown as blade interface 622. According to an exemplary embodiment, blade interface 622 is configured to allow for the removal of blades 612 from hub 614 to facilitate the storage of blades 612 either on a mobile system on a transport vehicle. Removing blades 612 may also reduce the structural loads transferred to the nacelle and hub, among other components of a mobile wind turbine during transport and redeployment of the mobile system.

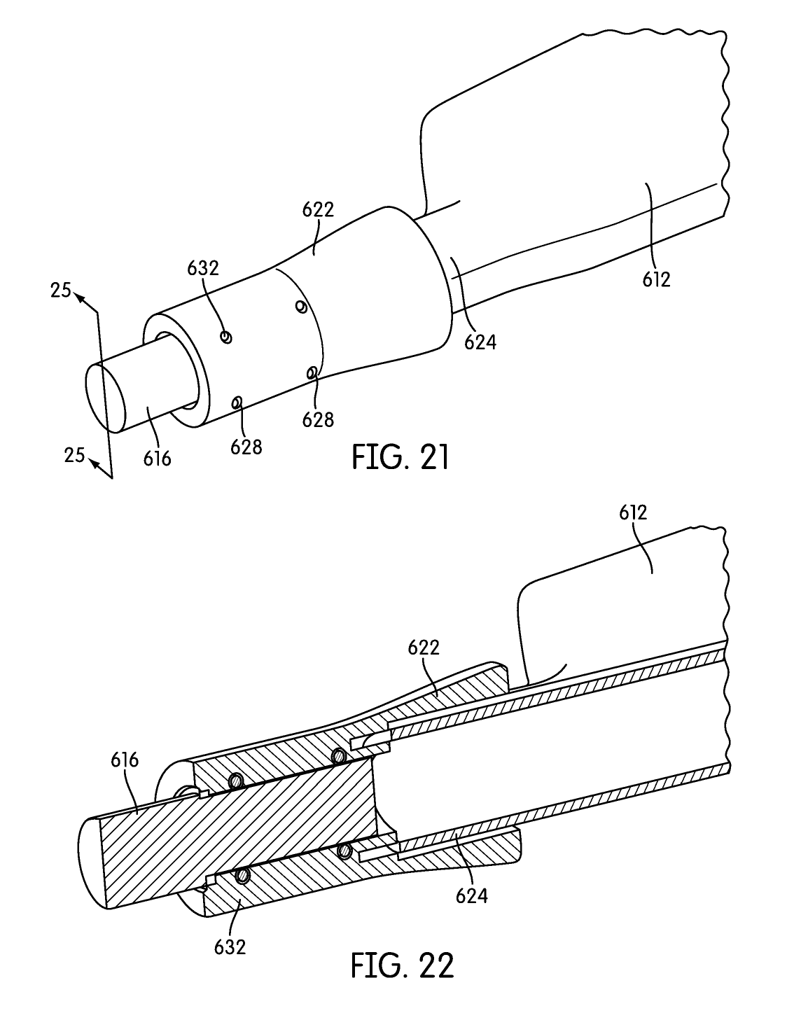

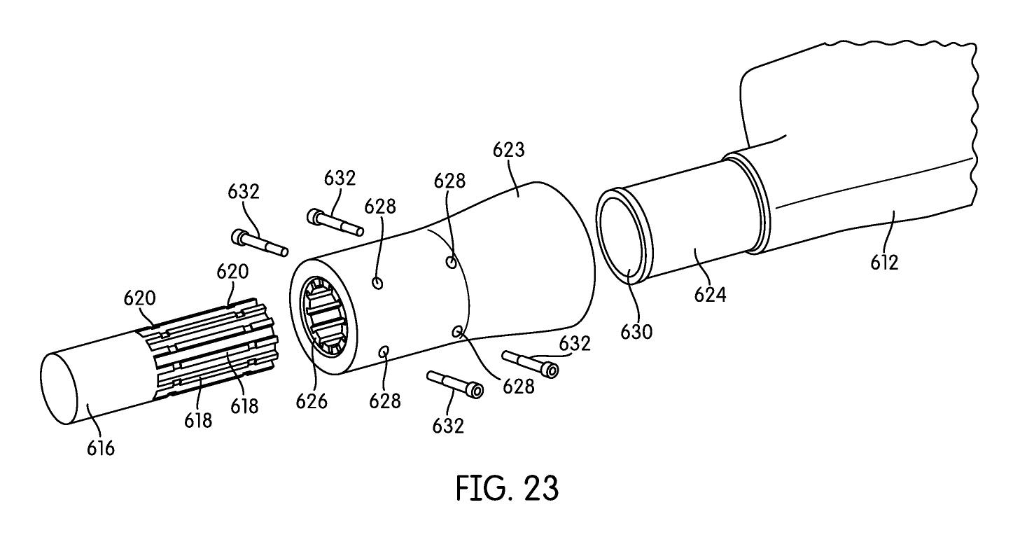

According to the exemplary embodiment shown in FIGS. 20-23, blade interface 622 may use a taper lock system for quick, accurate, and simple attachment and detachment of blades 612 from hub 614 with few components and limited use of tools. By way of example, such a taper lock system may require the use of only an Allen wrench to remove blade 612 from hub 614. As shown in FIG. 20, hub 614 may include a plurality of interfaces, shown as hub shafts 616. Hub shafts 616 may include a coupling portion, shown as splined end 618 and locking portions, shown as lateral grooves 620. As shown in FIG. 20, blade interface 622 may further include an interface member, shown as sleeve 623. Sleeve 623 may be configured to receive hub shaft 616 and a coupling portion of blade 612, shown as shaft 624 on opposite ends of blade interface 622. As shown in FIG. 23, sleeve 623 may further include an aperture having an interfacing portion, shown as female coupling 626 that may engage splined end 618.

According to an exemplary embodiment, a user may slide hub shaft 616 into sleeve 623. As shown in FIG. 23, shaft 624 may include an aperture, shown as relief 630 configured to receive an end of hub shaft 616. Shaft 624 may further include a locking lip proximate to the end of shaft 624 configured to secure blade 612 within sleeve 623. As shown in FIG. 23, sleeve 623 may further include a plurality of apertures 628 that extend transversely across the length of sleeve 623 and at least partially through a sidewall of sleeve 623. Once hub shaft 616 is properly in position within the sleeve 623, a user may insert a plurality of fasteners, shown as pins 632 (e.g., tapered lock bolts, etc.) through apertures 628. Such pins 632 may be received by lateral grooves 620 in hub shaft 616. Distal ends of the pins 632 may further extend through lateral grooves 620 and into apertures within the opposite side of sleeve 623 or may be secured with separate hardware. Such a configuration allows pins 632 to operate as sliding bolt locks (e.g., latches) that hold hub shaft 616 within sleeve 623 to couple blade 612 to hub 614. According to an exemplary embodiment, pins 632 may include a threaded portion actuated by a head configured to receive an Allen wrench. According to various alternative embodiments, more or fewer pins and lateral grooves may be used.

While FIGS. 15-23 show joint 310 and coupler 510 separately, it should be understood that a coupler, such as coupler 510 and a joint, such as joint 310 may be utilized together to couple a blade to a hub. Such a configuration may allow a user to selectively disconnect or fold the blades of a mobile wind turbine system. A user may wish to entirely remove the blades in order to facilitate long distance transport of the mobile wind turbine system while allowing for rapid assembly and the user may wish to fold the blades in order to facilitate rapid storage of the mobile wind turbine once assembled.

The construction and arrangements of the mobile wind turbine system and joints, as shown in the various exemplary embodiments, are illustrative only. Although only a few embodiments have been described in detail in this disclosure, many modifications are possible (e.g., variations in sizes, dimensions, structures, shapes and proportion of the various elements, values of parameters, mounting arrangements, use of materials, colors, orientations, etc.) without materially departing from the novel teachings and advantages of the subject matter described herein. Some elements shown as integrally formed may be constructed of multiple connectors or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes and omissions may also be made in the design, operating conditions and arrangement of the various exemplary embodiments without departing from the scope of the present invention.

What is claimed is:

1. A folding blade assembly for a mobile wind turbine system, comprising:
a hub configured to be coupled to a generator; and
a blade coupled to the hub with a movable joint, the movable joint comprising:
a first member coupled to the hub and having an aperture;
a second member coupled to the blade and having an aperture;
a pin extending through the apertures of the first and second members, wherein the second member is movable relative to the first member about the pin; and
a lock coupled to the first member and the second member and having an engaged position and a disengaged position, wherein the second member is movable relative to the first member when the lock is in the disengaged position.

2. The blade assembly of claim 1, wherein the lock further comprises a retainer coupled to at least one of the first and second members and the second member further comprises a receiver that interfaces with the retainer to configure the lock in at least one of the engaged position and the disengaged position.

3. The blade assembly of claim 2, wherein the receiver includes a second aperture positioned proximate to an end of the second member and configured to fix the orientation of the blade relative to the hub.

4. The blade assembly of claim 2, wherein the receiver includes a first space and a second space oriented between 70 and 110 degrees from the first space about the centerline of the apertures.

5. The blade assembly of claim 4, wherein the first member further includes a second aperture configured to receive the retainer such that extending the retainer through the second aperture and the first space fixes the blade in an operational configuration and extending the retainer through the second aperture and the second space fixes the blade in a storage configuration.

6. The blade assembly of claim 4, wherein the first and second spaces are grooves formed proximate to an end of the second member.

7. The blade assembly of claim 4, wherein rotation of the retainer to a first orientation engages at least one of the first and second spaces, and wherein rotation of the retainer to a second orientation disengages the at least one of the first and second spaces.

8. The blade assembly of claim 7, wherein the first orientation of the retainer is approximately 180 degrees from the second orientation about a center line of the retainer.

9. The blade assembly of claim 7, wherein the lock further comprises a limiter coupled to the first member and the retainer and configured to prevent movement of the retainer with respect to the first member.

10. The blade assembly of claim 9, wherein the lock further comprises a guide coupled to the first member and at least one of the retainer and the pin and configured to prevent movement of the at least one of the retainer and the pin with respect to the first member.

11. The blade assembly of claim 1, wherein the first member includes two extensions forming an area between the two extensions that receives an end of the second member.

12. The blade assembly of claim 1, wherein the lock comprises a plurality of interlocking teeth coupled to or integrally formed with the first and second members such that the second member may be rotationally indexed relative to the first member.

13. The blade assembly of claim 1, wherein the second member further comprises an interfacing end configured to receive and fasten an end of the blade.

14. A blade assembly for a mobile wind turbine system, comprising:
a hub configured to be coupled to a generator;
a first elongated member coupled to the hub;
a blade removably coupled to the first elongated member with a fastener, the fastener comprising:
a body element having a first aperture and a second aperture, wherein the first aperture is configured to receive an end of the first elongated member and the second aperture is configured to receive an end of the blade; and
a retainer configured to be received by a third aperture within the body element,
wherein the first elongated member further comprises at least one of a detent, aperture, and lateral groove that interfaces with the retainer to limit the movement of the blade with respect to the first elongated member.

15. The blade assembly of claim 14, wherein the first aperture includes a female spline coupling having lengthwise grooves and the first elongated member includes a male spline coupling having corresponding lengthwise grooves.

16. The blade assembly of claim 15, wherein the retainer comprises a ball bearing and the fastener further comprises a sleeve configured engage the ball bearing with the at least one of a detent, aperture, and lateral groove to interlock the body element and first elongated member.

17. The blade assembly of claim 16, wherein the fastener further comprises a locking ring coupled to the body element and a resilient member configured to bias the sleeve over the ball bearing, wherein compressing the resilient member with the sleeve allows the ball bearing to disengage the at least one of a detent, aperture, and lateral groove.

18. The blade assembly of claim 14, wherein the third aperture is located in a sidewall of the body element and the retainer comprises a pin coupled to the body element with a threaded connection.

19. A folding blade assembly for a mobile wind turbine system, comprising:
a hub configured to be coupled to a generator;
a first member having an aperture and coupled to the hub;
a second member having an aperture and coupled to the first member with a movable joint, the movable joint comprising:
an interface formed along a contact surface between the first member and the second member;
a pin extending through the apertures of the first and second members, wherein the second member is movable relative to the first member about the pin; and
a lock coupled to the first member and the second member and having an engaged position and a disengaged position, wherein the second member is movable relative to the first member when the lock is in the disengaged position;
a blade removably coupled to the second member with a fastener, the fastener comprising:
a body element having a first space and a second space, wherein the first space is configured to receive an end of the second member and the second space is configured to receive an end of the blade; and
a retainer configured to be received by a third space within the body element,
wherein the second member further comprises at least one of a detent, aperture, and lateral groove that interfaces with the retainer to limit the movement of the blade with respect to the second member.

20. The blade assembly of claim 19, wherein the first space includes a female spline coupling having lengthwise grooves and the second member includes a male spline coupling having corresponding lengthwise grooves.
